(19) United States
(12) Patent Application Publication
(10) Pub. No.: US 2009/0097383 A1
(43) Pub. Date: Apr. 16, 2009

(54) OPTICAL PICKUP APPARATUS

(75) Inventor: Taizoh YOKOTA, Higashihiroshima-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 12/247,900

(22) Filed: Oct. 8, 2008

(30) Foreign Application Priority Data
Oct. 10, 2007 (JP) 2007-264898

(51) Int. Cl. G11B 7/00

(52) U.S. Cl. 369/112.23; G9B/7

(57) ABSTRACT

An optical pickup apparatus includes: a light-emitting element for emitting laser light; a collimating lens for causing incident laser light to be converted into an optical beam and for emitting the optical beam thus converted; an objective lens for converging onto a recording surface of a recording medium the optical beam from the collimating lens; a light-receiving element for receiving reflected light from the recording medium; a collimating lens holder for holding the collimating lens; supporting means for supporting the collimating lens holder so that the collimating lens holder can freely move in an optical axis direction of the collimating lens; driving means for driving the collimating lens holder by electromagnetic force; and an elastic member, provided between a housing and the collimating lens holder, for pulling back the collimating lens holder to a neutral position in the optical axis direction of the collimating lens.

This Nonprovisional application claims priority under U.S.C. §119(a) on Patent Application No. 264898/2007 filed in Japan on Oct. 10, 2007, the entire contents of which are hereby incorporated by reference.

### FIELD OF THE INVENTION

The present invention relates to an optical pickup apparatus.

### BACKGROUND OF THE INVENTION

CDs (compact discs) are widely used as optical disks from which a signal is optically read out by use of an optical beam such as a laser beam. A high-density disc (DVD), a BD, and an HD-DVD, which BD and HD-DVD are ultrahigh-density discs, are proposed as optical disks that meet the needs for a further increase in storage capacity. The high-density disc is standardized for an increase in storage capacity. Specifically, the increase in storage capacity is realized by allowing high-density recording that is higher in density than a CD while ensuring mechanistic compatibility with a CD by employing the same disk diameter as that of a CD. The BD and the HD-DVD employ a blue-violet laser whose wavelength is much shorter than that of an infrared laser employed for DVDs.

A proposition is made as to doubling a storage capacity by providing a plurality of recording layers with a recording medium such as a high-density DVD, an ultrahigh-density BD, or an ultrahigh-density HD-DVD. In order for a recorded signal to be reproduced from a recording layer of stacked recording layers, it is necessary to correct, by moving a collimating lens in an optical axis direction, a spherical aberration generated due to the thickness of a covering layer. This is addressed by a conventionally proposed arrangement shown in FIG. 15(a) and FIG. 15(b). Specifically, in an optical pickup apparatus 100, a collimating lens 101 is slidable in an optical axis direction by use of a stepper motor 102, a shaft 103, and a mating gear 104. The shaft 103 transmits a driving force produced by the stepper motor 102 to the mating gear 104. The driving force thus transmitted causes the mating gear 104 to be rotated. This allows the collimating lens 101 to slide in the optical axis direction.

For the sake of dealing with different types of recording media, an optical pickup apparatus 105 is proposed (see FIG. 16(a) and FIG. 16(b)). The optical pickup apparatus 105 includes an aberration collecting mechanism with a beam expander 108. The beam expander 108 includes a collimating lens 101, a stepper motor 102, a collimating lens 107, a stepper motor 106, two shafts, and two mating gears. The optical pickup apparatus 105 accordingly can deal with a recording medium 109 illustrated in FIG. 15(c) and a recording medium 110 illustrated in FIG. 16(c), whose protective substrate has a different thickness. In FIG. 16, a single stepper motor is provided in the beam expander 108. Alternatively, two stepper motors may be provided in the beam expander 108. Furthermore, another correction of a spherical aberration for an arrangement in which a liquid crystal element is adopted has been proposed.

Japanese Unexamined Patent Publication No. 2007-26615 (Tokukai 2007-26615, published on Feb. 1, 2007) discloses an optical pickup including a collimating lens as in the cases of the optical pickup apparatuses illustrated in FIGS. 15 and 16. The optical pickup suitably records and reproduces information, with no loss in light amount and the same rim intensity, to and from each of two optical recording media that are different in numerical aperture and thickness of substrate. Japanese Unexamined Patent Publication No. 2007-115303 (Tokukai 2007-115303, published on May 10, 2007) discloses an optical head apparatus in which a compatible head has objective lenses with different diameters of entrance pupils so as to be in conformity with a plurality of types of recording media whose standards are different from each other. The compatible head can detect, for each of the standards with high precision, a spherical aberration generated in a collecting optical system and properly correct the spherical aberration. As a result, the optical head apparatus can properly record and reproduce information to and from an optical disk. In addition, Japanese Unexamined Patent Publication No. 2005-317120 (Tokukai 2005-317120, published on Nov. 10, 2005) discloses an optical pickup that compensates with a simple arrangement a spherical aberration generated by a difference in thickness between protective substrates of recording media or by a difference in thickness between recording layers of the recording media.

Unfortunately, a conventional optical pickup apparatus that drives the collimating lens in an optical axis direction by use of a stepper motor causes an increase in cost because the stepper motor, which is an expensive member, is required. In addition, the conventional optical pickup apparatus requires a driving circuit for the stepper motor. This leads to a further increase in cost. Moreover, it is difficult to miniaturize the conventional optical pickup apparatus because of the size of the stepper motor. This leads to an increase in size of a drive unit to which the optical pickup apparatus is mounted. Accordingly, it is believed that an optical head apparatus disclosed in Japanese Unexamined Patent Publication No. 2007-115303 (Tokukai 2007-115303, published on May 10, 2007) has a large size because of its employed structure that allows a concave lens, which is a beam expander lens, to move backward and forward along an optical axis by a driving apparatus having a stepper motor.

Further, the conventional aberration correction by use of a liquid crystal element requires a liquid crystal element that is expensive and has a complicated structure. Accordingly, this leads to a complicated circuit configuration of a driving circuit for the liquid crystal element. This results in a problem that the liquid crystal element and the driving circuit of the liquid crystal element cause an increase in cost.

### SUMMARY OF THE INVENTION

In view of the problems, an object of the present invention is to provide an inexpensive highly reliable optical pickup apparatus that is capable of correction of a spherical aberration of a spot on a recording surface of each of a plurality of recording media having respective protective layers that are mutually different in thickness.

In order to attain the object, an optical pickup apparatus includes: a light source for emitting laser light; a collimating lens for causing incident laser light to be converted into an optical beam that is in a collimated state, a divergent state, or a convergent state, and for emitting the optical beam thus converted; an objective lens for converging onto a recording surface of a recording medium the optical beam from the collimating lens; a light-receiving element for receiving reflected light from the recording medium; a collimating lens holder for holding the collimating lens; supporting means for supporting the collimating lens holder so that the collimating lens holder can freely move in an optical axis direction of the collimating lens; driving means for driving the collimating lens holder by electromagnetic force; and a neutral position recovery member, provided between a housing and the collimating lens holder, for pulling back the collimating lens holder to a neutral position in the optical axis direction of the collimating lens, while no electromagnetic force is exerted on the collimating lens holder.

According to the invention, sliding the collimating lens to a desired position by use of an electromagnetic force produced by the driving means causes the optical beam to become collimated or non-collimated. The optical pickup apparatus thus generates an optical beam with an opposite spherical aberration for canceling a spherical aberration caused by one protective layer. As a result, the optical pickup apparatus can correct a spherical aberration of a spot on a multilayered recording surface of each of a plurality of recording media having respective protective layers that are mutually different in thickness.

In addition, the provision of the supporting means and the driving means allows the collimating lens to freely move in the optical axis direction. This makes it possible to always obtain fine recording/reproducing characteristics. Furthermore, the collimating lens is always kept in a constant position by the operation of the neutral position recovery member, which is, for example, an elastic member, even while an apparatus including the optical pickup apparatus is turned OFF. As a result, this allows the provision of an inexpensive highly reliable optical pickup apparatus that reduces the next startup time of reproduction and thereby maintains amenity in use.

Moreover, the optical pickup apparatus includes the elastic member. This saves more space when compared with a case where a conventional stepper motor is provided. None the less, the neutral position recovery member produces resilience for pulling back the collimating lens holder to the neutral position (resilience for neutral positioning) that resilience is almost linearly proportional in a moving range of the collimating lens holder. This allows a stable correction of a spherical aberration.

### BRIEF DESCRIPTION OF THE DRAWINGS

FIG. 1(a) is an elevation view illustrating an optical pickup apparatus of one embodiment of the present invention. FIG. 1(b) is a plan view illustrating the optical pickup apparatus of the one embodiment of the present invention. FIG. 1(c) is a view illustrating a recording medium being irradiated with an optical beam.

FIG. 2(a) is a plan view illustrating the optical pickup apparatus of the one embodiment of the present invention. FIG. 2(b) is a view illustrating a recording medium being irradiated with an optical beam.

FIG. 3(a) is a plan view illustrating the optical pickup apparatus of the one embodiment of the present invention. FIG. 3(b) is a view illustrating a recording medium being irradiated with an optical beam.

FIG. 4 is a plan view illustrating (i) a surface of a diffractive element that surface diffracts reflected light from the recording medium so as to direct the reflected light toward a light-receiving element and (ii) the light-receiving element.

FIG. 5 is a view illustrating one example of an optical pickup apparatus that includes a guiding rail formed, instead of the shaft, in a housing.

FIG. 6 is a view illustrating an electromagnetic force generated by an electric current passing through a first coil and a magnetic field generated by a first magnet.

FIG. 7(a) is a plan view illustrating an optical pickup apparatus including a first neutral positioning rubber member having a zigzag shape that is formed by folding a neutral positioning rubber member several times. FIG. 7(b) is a view illustrating a recording medium being irradiated with an optical beam when using the optical pickup apparatus illustrated in FIG. 7(a).

FIG. 8(a) is a graph showing a property of resilience of the neutral positioning rubber member with respect to a moving distance of the collimating lens. FIG. 8(b) is a plan view illustrating the optical pickup apparatus with a collimating lens holder positioned in a first neutral position. FIG. 8(c) is a plan view illustrating the optical pickup apparatus with the collimating lens holder moved close to a semiconductor laser package. FIG. 8(d) is a plan view illustrating the optical pickup apparatus with the collimating lens holder moved away from the semiconductor laser package.

FIG. 9 is a block diagram illustrating an arrangement of controlling sections of an optical disk drive that includes the optical pickup apparatus of the one embodiment of the present invention.

FIG. 10(a) is an elevation view illustrating an optical pickup apparatus of another embodiment of the present invention. FIG. 10(b) is a plan view of the optical pickup apparatus of the another embodiment of the present invention. FIG. 10(c) is a view illustrating a recording medium being irradiated with an optical beam.

FIG. 11(a) is a plan view illustrating the optical pickup apparatus of the another embodiment of the present invention. FIG. 1 1 (b) is a view illustrating a recording medium being irradiated with an optical beam.

FIG. 12(a) is a plan view illustrating the optical pickup apparatus of the another embodiment of the present invention. FIG. 12(b) is a view illustrating a recording medium being irradiated with an optical beam.

FIG. 13(a) is a plan view illustrating the optical pickup apparatus of the another embodiment of the present invention. FIG. 13(b) is a view illustrating a recording medium being irradiated with an optical beam.

FIG. 14(a) is a plan view illustrating an optical pickup apparatus including a first neutral positioning rubber member and a second neutral positioning rubber member that having a zigzag shape that is formed by folding a neutral positioning rubber member several times. FIG. 14(b) is a view illustrating a recording medium being irradiated with an optical beam when using the optical pickup apparatus illustrated in FIG. 14(a).

FIG. 15(a) is an elevation view illustrating a conventional optical pickup apparatus. FIG. 15(b) is a plan view illustrating the conventional optical pickup apparatus. FIG. 15(c) is a view illustrating a recording medium being irradiated with an optical beam.

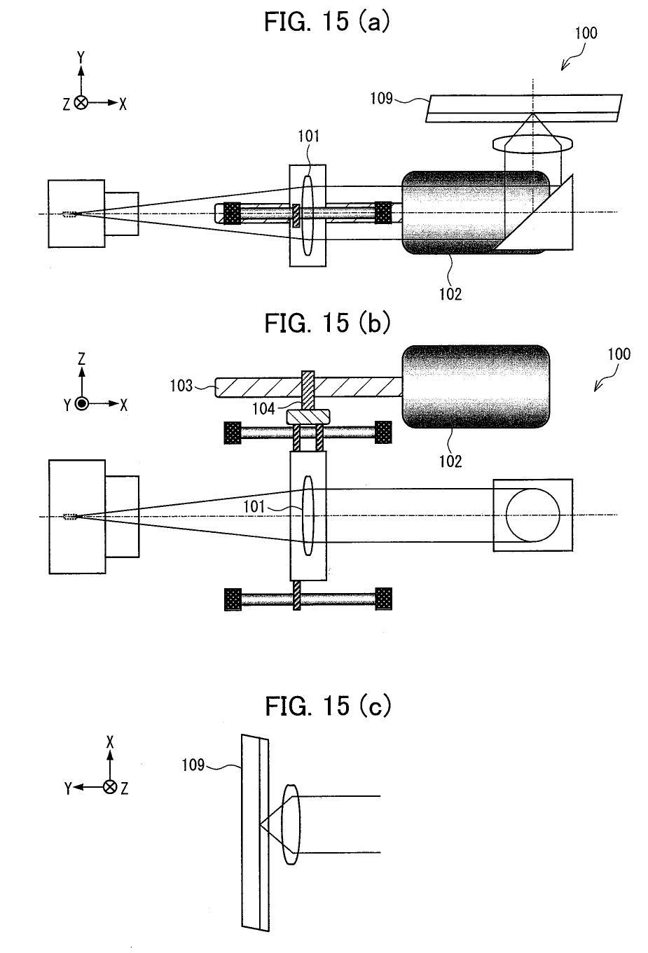

FIG. 16(a) is an elevation view illustrating another conventional optical pickup apparatus. FIG. 16(b) is a plan view illustrating the another conventional optical pickup apparatus. FIG. 16(c) is a view illustrating another recording medium being irradiated with an optical beam.

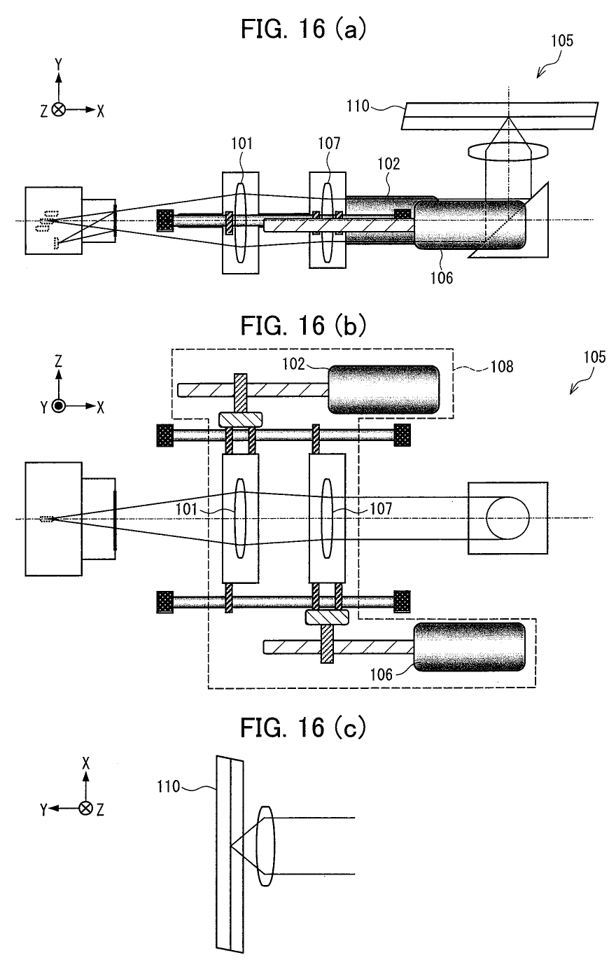

### DESCRIPTION OF THE EMBODIMENTS

### First Embodiment

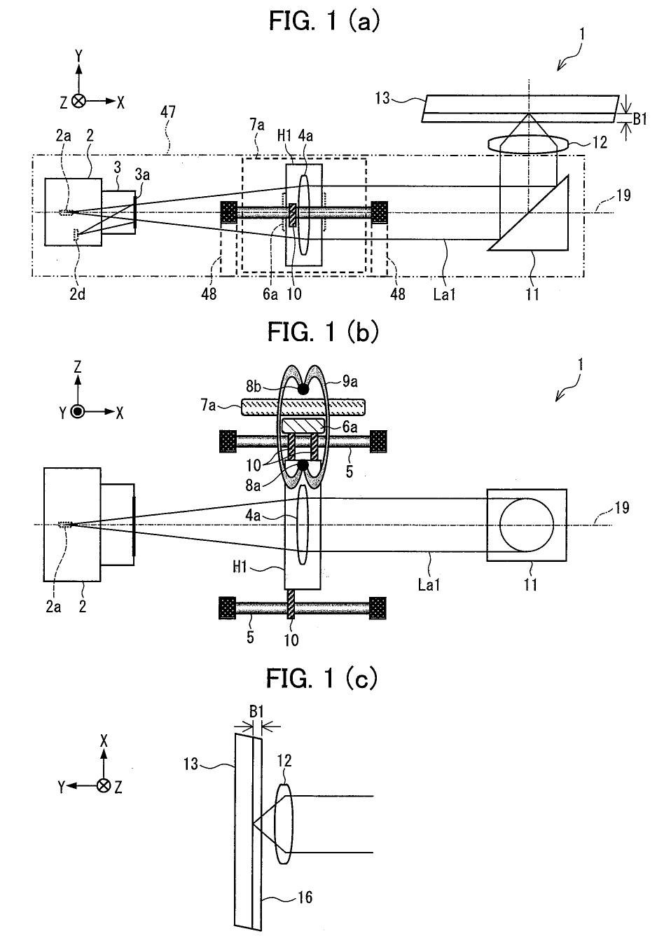

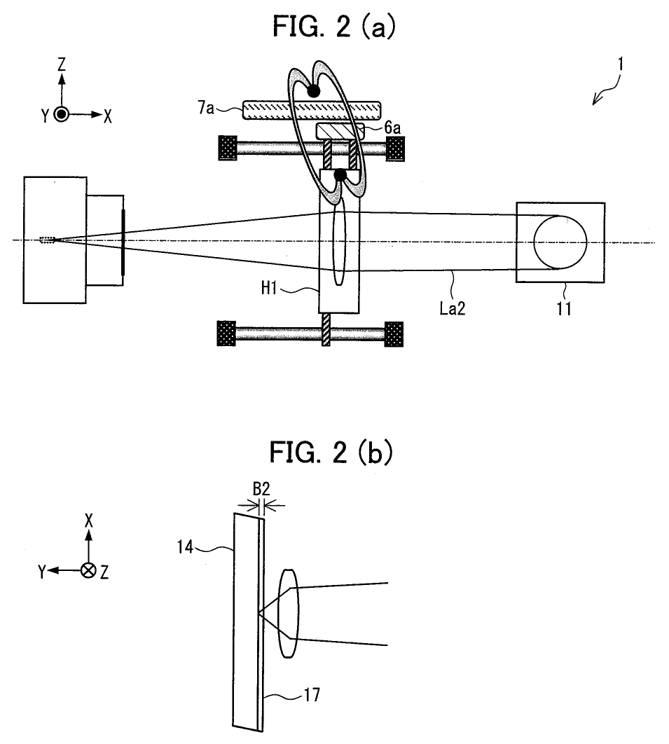

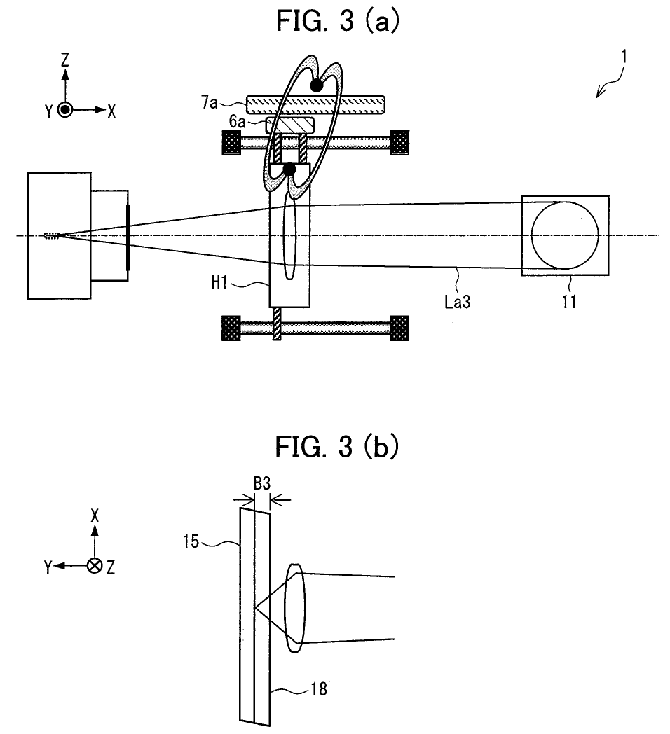

The following describes one embodiment of the present invention with reference to FIGS. 1 through 9. FIGS. 1 through 3 illustrate an optical pickup apparatus 1 of the present embodiment. FIG. 1(a) is an elevation view illustrating the optical pickup apparatus 1. FIG. 1(b), FIG. 2(a), and FIG. 3(a) are plan views illustrating the optical pickup apparatus 1. FIG. 1(c), FIG. 2(b), and FIG. 3(b) are views illustrating disk-shaped recording media (hereinafter, referred to as “recording medium/media”) 13, 14, and 15, respectively, each recording medium being irradiated with an optical beam. The recording media have respective protective substrates that are mutually different in thickness.

The optical pickup apparatus 1 broadly includes a semiconductor laser package 2, a hologram substrate 3, a first collimating lens 4a, a first collimating lens holder H1, a shaft 5, a first coil 6a, a first magnet 7a, a first neutral positioning rubber member 9a, a sliding bearing 10, a reflecting mirror 11, and an objective lens 12.

The semiconductor laser package 2 includes a light-emitting element (a light source) 2a and a light-receiving element 2d. The hologram substrate 3 includes a surface 3a of a diffractive element (hereinafter, the surface 3a of the diffractive element is referred to as surface 3a). The surface 3a diffracts reflected light from the recording medium so as to direct the reflected light toward the light-receiving element 2d.

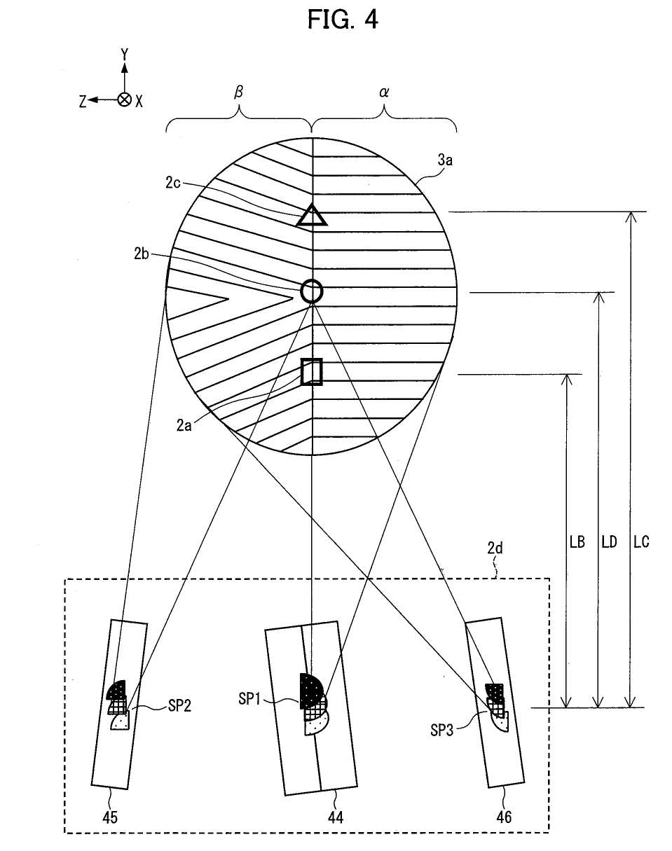

FIG. 4 is an explanatory view illustrating the surface 3a that diffracts the reflected light from the recording medium so as to direct the reflected light toward the light-receiving element 2d. The surface 3a has a circular shape. The surface 3a has two regions α and β separated by a straight line that is oriented in a Y-axis direction and that passes through the center of the surface 3a (hereinafter, referred to as center). The region α is positioned in a −Z direction and the region β is positioned in a +Z direction, where the position of the center is expressed as Z=0.

The light-receiving element 2d includes light-receiving sections 44 through 46. Reflected light from the recording medium is diffracted by the region a and then the light-receiving section 44 receives at a spot SP1 the light thus diffracted. In addition, the reflected light from the recording medium is diffracted by the region β and then the light-receiving sections 45 and 46 receive at spots SP2 and SP3 the light thus diffracted, respectively. LB represents a distance in the Y-axis direction between the light-emitting element 2a and the spot SP1. FIG. 4 also illustrates light-emitting elements 2b and 2c included in the semiconductor laser package 2. The light-emitting elements 2b and 2c are later described in detail in a second embodiment. In FIG. 4, LD represents a distance in the Y-axis direction between the light-emitting element 2b and the spot SP1. LC represents a distance in the Y-axis direction between the light-emitting element 2c and the spot SP1.

Focus detection by a knife-edge method can be carried out with the use of light diffracted by the α region. A tracking error signal can be detected from light diffracted by the region β.

Laser light emitted from the light-emitting element 2a passes through the first collimating lens 4a held by the first collimating lens holder H1. This causes the laser light to become a substantially collimated optical beam. Then, the reflecting mirror 11 changes the direction of the optical beam so that the optical beam is converged onto the recording medium 13, 14, or 15 by the objective lens 12.

Each of the recording media 13, 14, and 15 has a multilayered structure. Specifically, the recording medium 13 is arranged so that its protective substrate 16 having a thickness of B1 is provided on the side from which the optical beam is entered for readout. The recording medium 14 is arranged so that its protective substrate 17 having a thickness of B2 that is thinner than the thickness B1 is provided on the side from which the optical beam is entered for readout. The recording medium 15 is arranged so that its protective substrate having a thickness of B3, which is thicker than the thickness B1, is provided on the side from which the optical beam is entered for readout.

The first collimating lens holder H1 includes on both side surfaces the sliding bearings 10 having a hole. The sliding bearings are provided for a smooth slide of the first collimating lens holder H1. Two shafts 5 fixed to supports 48 of a housing 47 are provided so as to be fitted into the holes of the sliding bearings 10, respectively. This causes the first collimating lens holder H1 to be supported by the shafts 5 so that the first collimating lens holder H1 is slidable in a direction of an optical axis 19 (i.e., in an X-axis direction). This makes it possible to realize a stable highly reliable optical pickup apparatus.

The first collimating lens holder H1 may be provided so as to slide along a convex guiding rail or along a concave guiding section, which is formed, instead of the shafts 5, in the housing 47. This makes it possible to realize, without an expensive polished shaft, an inexpensive optical pickup apparatus.

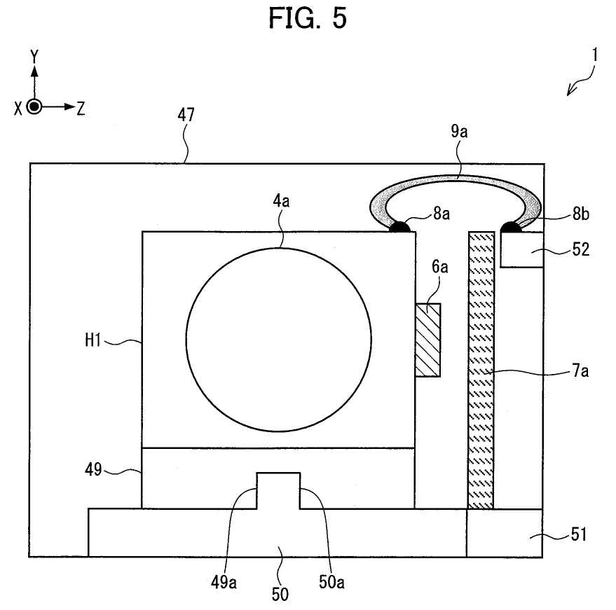

FIG. 5 is a view illustrating one example of an optical pickup apparatus that adopts a guiding rail 50 formed, instead of the shafts 5, in the housing 47. In FIG. 5, the guiding rail 50 having a convex shape is formed in the housing 47. A concave guiding section 49 is attached to the collimating lens holder H1. With the arrangement, the collimating lens 4a held by the collimating lens holder H1 can freely slide in the X-axis direction because a convex part 50a of the guiding rail 50 is slidably fitted into a concave part 49a of the guide section 49. The first coil 6a is attached to the collimating lens holder H1. The first magnet 7a is attached to a magnet support 51 so as to face the first coil 6a. A supporting point 8b is attached to a supporting point support 52. The magnet support 51 and the supporting point support 52 are formed in the housing 47. The arrangement illustrated in FIG. 5 is merely one example. Therefore, the present embodiment is not limited to this, provided that the collimating lens 4a can freely move in the X-axis direction by use of the guiding section 49 and the guiding rail 50.

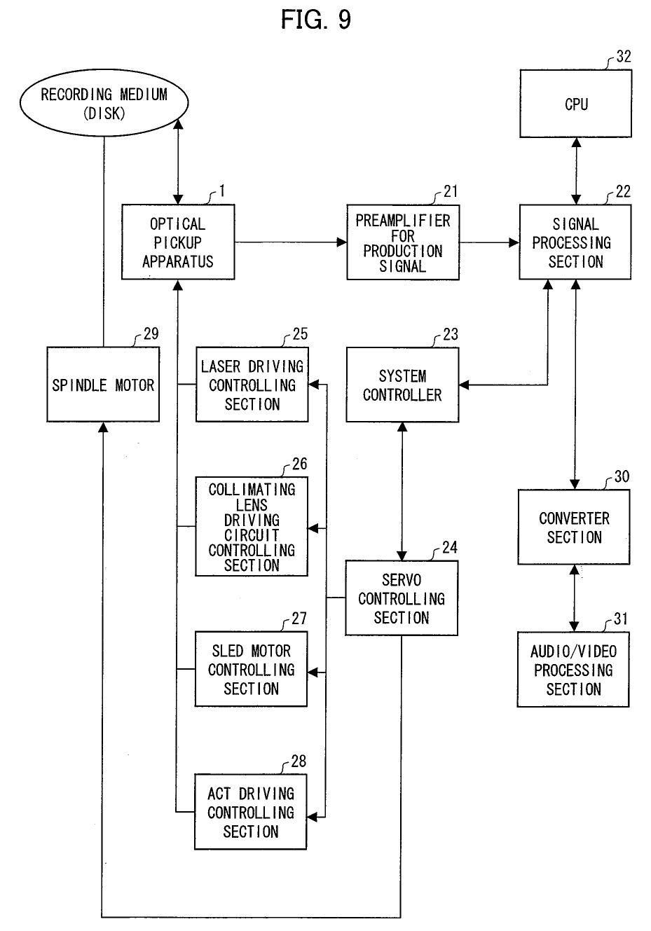

The first coil 6a is attached to the sliding bearings 10. In the housing 47, further, the first magnet 7a is provided so as to face the first coil 6a. Although details are described later, under Fleming's left hand rule which is a universal rule of electromagnetic actuation, the amplitude and the polarity of an electric current flowing through the first coil 6a are controlled by control means (not illustrated) in accordance with a signal supplied by a later described collimating lens driving circuit controlling section 26 (see FIG. 9). This causes the first collimating lens holder HI to slide in the X-axis direction so that the first collimating lens holder H1 is adjusted to be in a desired position. The laser light emitted from the light-emitting element 2a passes through the first collimating lens 4a and comes out as an optical beam (hereinafter, referred to as collimated beam). A fine adjustment of position of the first collimating lens 4a on the optical axis 19 can bring the collimated beam into any one state of a collimated state La1 (see FIG. 1(b)), a convergent state La2 (see FIG. 2(a)), and a divergent state La3 (see FIG. 3(a)).

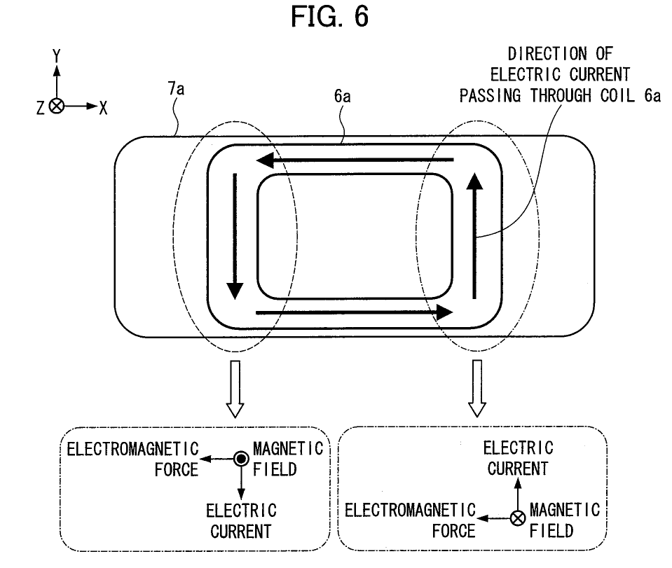

FIG. 6 is an elevation view illustrating the first coil 6a and the first magnet 7a, which are extracted from the arrangement illustrated in FIG. 1(a). FIG. 6 illustrates an electromagnetic force that is caused by an electric current flowing through the first coil 6a and a magnetic field generated by the first magnet 7a. In FIG. 6, in a region, indicated by a dashed line, of the first coil 6a, an electromagnetic force is caused in a −X direction by an electric current in a −Y direction and a magnetic field in the −Z direction in accordance with Fleming's left hand rule. In a region, indicated by a dashed-dotted line, of the first coil 6a d, an electromagnetic force is caused in the −X direction by an electric current in a +Y direction and a magnetic field in the +Z direction. Accordingly, the collimating lens holder H1 can slide in the −X direction in accordance with the electromagnetic force which is exerted, in the −X direction, on the first coil 6a. When the electric current flows through the first coil 6a in a reverse direction to the direction illustrated in FIG. 6a, an electromagnetic force is exerted, in a +X direction, on the first coil 6a in accordance with Fleming's left hand rule. This allows the collimating lens holder H1 to slide in the +X direction.

The present embodiment deals with an arrangement in which the first collimating lens holder H1 is supported by the two shafts 5, or by the guiding section 49 and the guiding rail 50 which is fitted into the guiding section 49. However, the present embodiment is not limited to this, provided that the first collimating lens holder H1 can slide in the X-axis direction. For example, the first collimating lens holder H1 can be supported by a single shaft.

As to the relative position of the first coil 6a and the first magnet 7a, they may be interchanged. Specifically, the first coil 6a may be fixed to the housing 47 and the first magnet 7a may be attached to the first collimating lens holder H1. This eliminates the need for current supply to the first collimating lens holder H1, which is a moving section. Accordingly, the first collimating lens holder H1 can be driven with current supply to the first coil 6a, which is fixed to the housing 47. This eliminates the need for an FPC and an extra-fine twisted wire that are used for current supply to the moving section. As a result, it is possible to provide a low-cost highly reliable driving apparatus.

The first neutral positioning rubber member 9a is a member for keeping the first collimating lens holder H1 in a neutral position, namely, in a position for causing an incident optical beam onto the objective lens 12 to become collimated. One end of the first neutral positioning rubber member 9a is fixed to a supporting point 8a provided on the first collimating lens holder H1 and the other end of the first neutral positioning rubber member 9a is fixed to the supporting point 8b provided to the housing 47. The supporting points 8a and 8b are provided to keep a predetermined distance in a Z-axis direction, which is perpendicular to (i) the optical axis direction of the objective lens 12 (i.e., the Y-axis direction) and (ii) the X-axis direction. As illustrated in FIG. 1(b), FIG. 2(a), and FIG. 3(a), in the present embodiment, two rubber members each having a shape of an incomplete ring (part of a ring is cut out) are used as the first neutral positioning rubber member 9a. This saves more space when compared with a case where a conventional stepper motor is provided. Furthermore, the first neutral positioning rubber member 9a produces resilience, for neutral positioning, that is almost linearly proportional in a moving range of the collimating lens holder H1. This allows a stable correction of a spherical aberration.

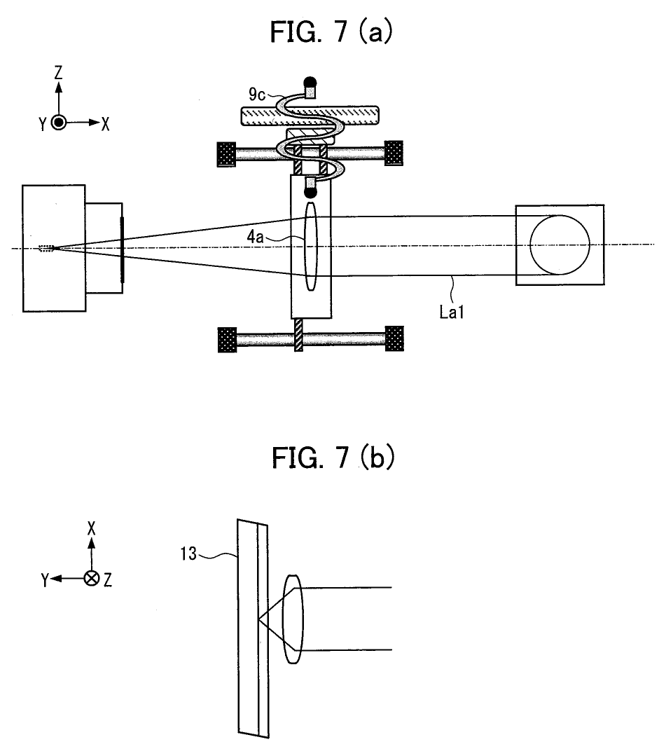

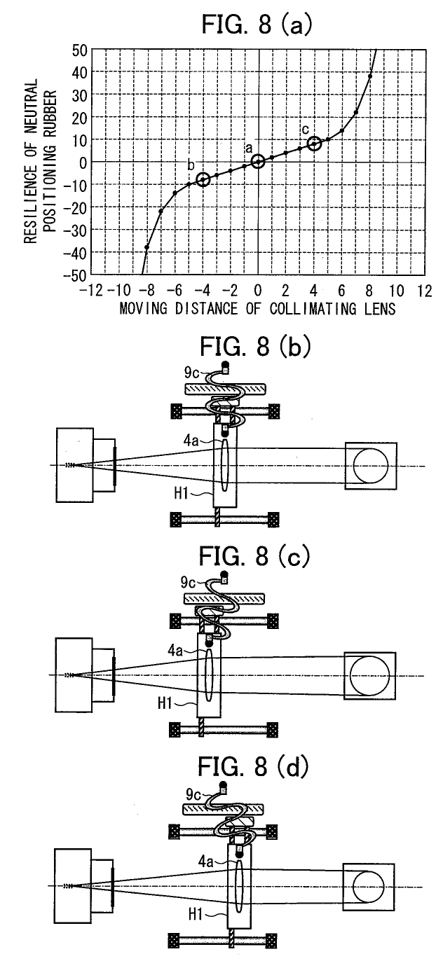

As illustrated in FIG. 7(a), a first neutral positioning rubber member 9c, having a zigzag shape, that is formed by folding a strip rubber member several times may be used instead of the first neutral positioning rubber member 9a. FIG. 7(b) is a view illustrating a recording medium being irradiated with an optical beam when using the optical pickup apparatus illustrated in FIG. 7(a). The below describes an operation of the first neutral positioning rubber members 9a and 9c with reference to a graph in FIG. 8.

FIG. 8(a) is a graph showing how resilience of each of the neutral positioning rubber members 9a and 9c with respect to a moving distance of the first collimating lens 4a (hereinafter, referred to as resilience) is changed. In the graph in FIG. 8(a), a longitudinal axis indicates resilience, namely, the force by which the first neutral positioning rubber member 9c pulls the first collimating lens holder H1 back to the neutral position. A transverse axis indicates a moving distance of the first collimating lens 4a.

The position of the first collimating lens 4a is 0 mm when, as illustrated in FIG. 8(b), the first collimating lens holder H1 is positioned in the neutral position. This state corresponds to a point a in FIG. 8(a). In this state, the resilience is ON.

In FIG. 8(c), the first collimating lens holder H1 is moved toward the semiconductor laser package 2. In this state, the position of the first collimating lens 4a is −4 mm. This state corresponds to a point b in FIG. 8(a). In FIG. 8(d), conversely, the first collimating lens holder H1 is moved away from the semiconductor laser package 2. In this state, the position of the first collimating lens 4a is +4 mm. This state corresponds to a point c in FIG. 8(a).

In the range between the points b and c, the first neutral positioning rubber members 9a and 9c each produce the resilience that is almost linearly proportional in a moving distance of the first collimating lens 4a. As compared with a case where a conventional stepper motor is used, when moving the first collimating lens 4a within the moving range, it is possible to realize a simpler lower-cost aberration correcting mechanism that allows an easier correction of a spherical aberration. Furthermore, it is possible to obtain a strength for keeping a neutral position, which strength is almost linearly proportional in a moving distance of the collimating lens within a movable range of the collimating lens, namely, within a range in which the collimating lens holder can slide. As compared with a case where a conventional stepper motor is provided, this makes it possible to realize an aberration correcting mechanism that saves more space and has a property of strength for keeping a neutral position, which strength shows a higher linearity in the proportionality.

In the present embodiment, a rubber member is used as the first neutral positioning rubber members 9a and 9c. However, the first neutral positioning rubber members 9a and 9c are not limited to the rubber member, provided that a linear resilience for neutral positioning is realized. For example, a leaf spring may be used instead of the first neutral positioning rubber members 9a and 9c.

The objective lens 12 is designed so that a spherical aberration of a spot on a recording surface of the recording medium 13 can be minimized by bringing a collimated beam into the collimated state La1 when the recording medium 13 with the protective substrate 16 having a thickness of B1 is irradiated with an optical beam by use of the optical pickup apparatus 1. However, in a case where, as in the case of the recording medium 14, the thickness B2 of the protective substrate 17 is thinner than the thickness B1 of the protective substrate 16, the collimated beam needs to be brought into the convergent state La2 so that a spherical aberration is corrected. A spherical aberration caused by an error in thickness of the protective substrate is said to be proportional to a value determined by the following expression (1), where the thickness of the protective substrate is represented by t; the refractive index of a substrate is represented by n; and the numerical aperture of an objective lens is represented by NA.

t×(n²−1)/(n³)×(NA)⁴ (1)

FIG. 2(b) illustrates the recording medium 14 with the protective substrate 17 having a thickness of B2, as an example in which a thickness t of a protective substrate is thinner than the thickness B1 of the protective substrate 16. In order for an optical beam to be converged onto a recording surface of the recording medium 14, as illustrated in FIG. 2(a), the first collimating lens holder H1 is slid toward the reflecting mirror 11. The first collimating lens holder H1 is slid by an electromagnetic force caused by an electric current flowing through the first coil 6a and a magnetic field generated by the first magnet 7a. This brings the collimated beam, which has passed through the first collimating lens 4a, into the convergent state La2. Then, the direction of the collimated beam is changed toward the recording medium by the reflecting mirror 11 so that the collimated beam enters the objective lens 12. A spherical aberration is thus corrected.

FIG. 3(b) illustrates the recording medium 15 with the protective substrate 18 having a thickness of B2, as an example in which a thickness t of a protective substrate is thicker than the thickness B1 of the protective substrate 16. In order for an optical beam to be converged onto a recording surface of the recording medium 15, as illustrated in FIG. 3(a), the first collimating lens holder H1 is slid toward the semiconductor laser package 2. The first collimating lens holder H1 is slid by an electromagnetic force caused by an electric current flowing through the first coil 6a and a magnetic field generated by the first magnet 7a. This brings the collimated beam, which has passed through the first collimating lens 4a, into the divergent state La3. Then, the direction of the collimated beam is changed toward the recording medium by the reflecting mirror 11 so that the collimated beam enters the objective lens 12. A spherical aberration is thus corrected.

In order for a spherical aberration, caused by an error in thickness of a protective substrate, to be corrected in either case of a thick protective substrate or a thin protective substrate of a recording medium, the first collimating lens holder H1 is slid by an electromagnetic force caused by the first coil 6a and the first magnet 7a so that the degree of convergence/divergence of the collimated beam is changed, and then the collimated beam thus changed enters the objective lens 12. The first collimating lens holder H1 is thus slid so that a spherical aberration caused by an error in thickness of a substrate is cancelled.

FIG. 9 is a block diagram illustrating an arrangement of controlling sections of an optical disk drive that includes the optical pickup apparatus 1. A reproduction signal read out from a recording medium (disk) by the optical pickup apparatus 1 is transmitted to a system controller 23, via a preamplifier 21 for reproduction signal and a signal processing section 22. Based on the reproduction signal thus read out, the system controller 23 identifies the disk. A servo controlling section 24 transmits signals to a laser driving controlling section 25, a collimating lens driving circuit controlling section 26, a sled motor controlling section 27, and an ACT driving controlling section 28, respectively. This controls a semiconductor laser, a collimating lens driving circuit, an ACT, and a sled motor in a mechanical section, which are provided in the optical pickup apparatus 1. The servo controlling section 24 further transmits a signal to a spindle motor 29 so that the number of revolutions of the disk is controlled. The reproduction signal is further transmitted to an audio/video processing section 31 via a converter section 30. The converter section 30 includes a D/A converter and an A/D converter. A CPU 32 is connected to the signal processing section 22. The CPU 32 carries out various kinds of arithmetic operations.

As described above, with the optical pickup apparatus 1 of the present embodiment having a simple arrangement in which the first coil 6a, the first magnet 7a, and the first neutral positioning rubber member 9a are provided, the collimating lens is slid to a desired position so that the optical beam becomes collimated or non-collimated. This causes a generation of an optical beam having a reverse spherical aberration for canceling a spherical aberration caused by one protective layer. As a result, the optical pickup apparatus 1 can correct the spherical aberration of a spot on a recording surface of each of a plurality of recording media whose protective layers have thicknesses different from each other.

In addition, with the first coil 6a, the first magnet 7a, and the first neutral positioning rubber member 9a, the collimating lens 4a can freely move in the optical axis direction. As a result, it is always possible to obtain fine recording/reproducing characteristics.

Furthermore, in a case where a product including the optical pickup apparatus 1 is turned off and therefore no electric current flows through the first coil 6a, the first collimating lens holder H1 is kept in the neutral position by the operation of the first neutral positioning rubber member 9a. As such, the time, required for startup of reproduction after the product is turned on again, is reduced, and the first collimating lens 4a can move to the most appropriate position in a short period of time. As a result, this allows the provision of an inexpensive highly reliable optical pickup apparatus 1 that maintains amenity in use.

Moreover, the optical pickup apparatus 1 includes the first neutral positioning rubber member 9a. This saves more space when compared with a case where a conventional stepper motor is provided. Furthermore, the first neutral positioning rubber member 9a produces resilience, for neutral positioning, that is almost linearly proportional in a moving range of the first collimating lens holder H1. This allows a stable correction of a spherical aberration.

### Second Embodiment

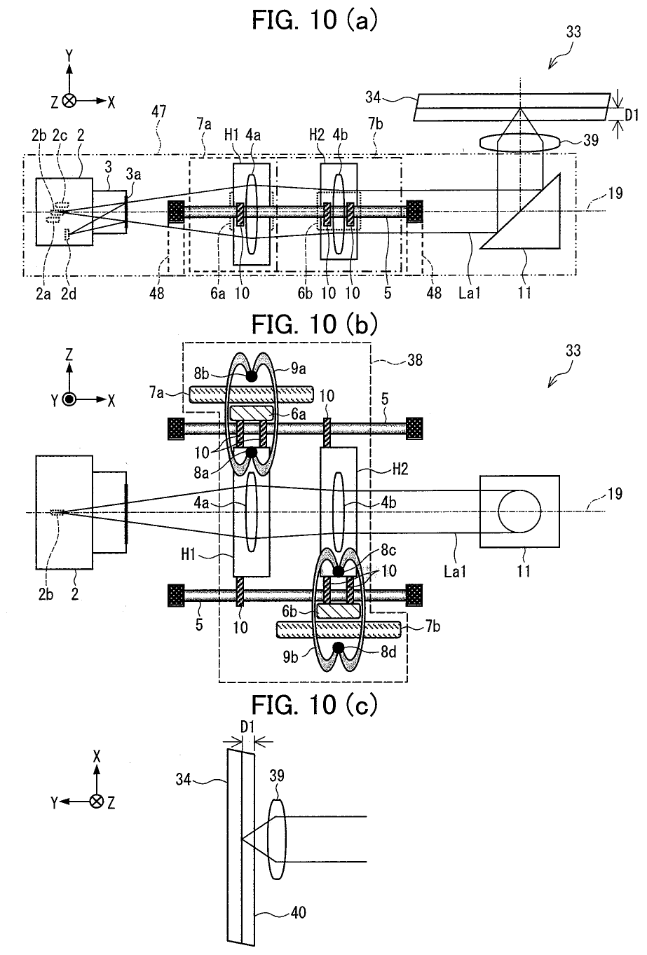

The following describes another embodiment of the present invention with reference to FIGS. 10 through 14. Except for arrangements described in the present embodiment, the present embodiment has the same arrangements as those of the first embodiment. For convenience of explanation, members having the same functions as those illustrated in the figures of the first embodiment are given the same reference letters and numerals, and descriptions for the members are omitted.

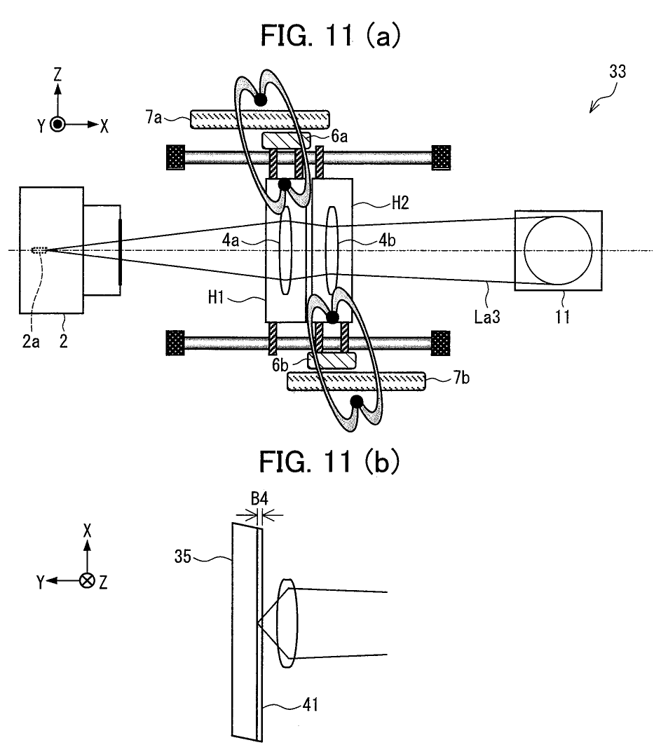

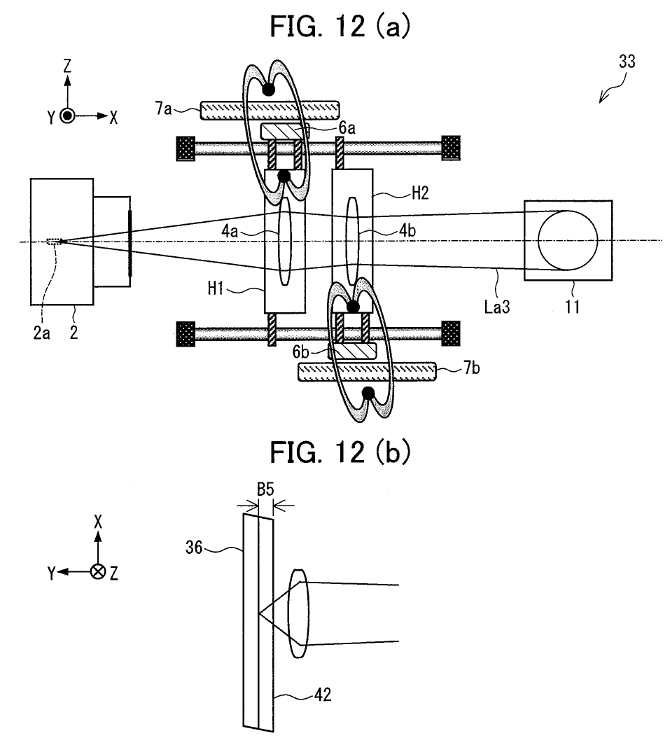

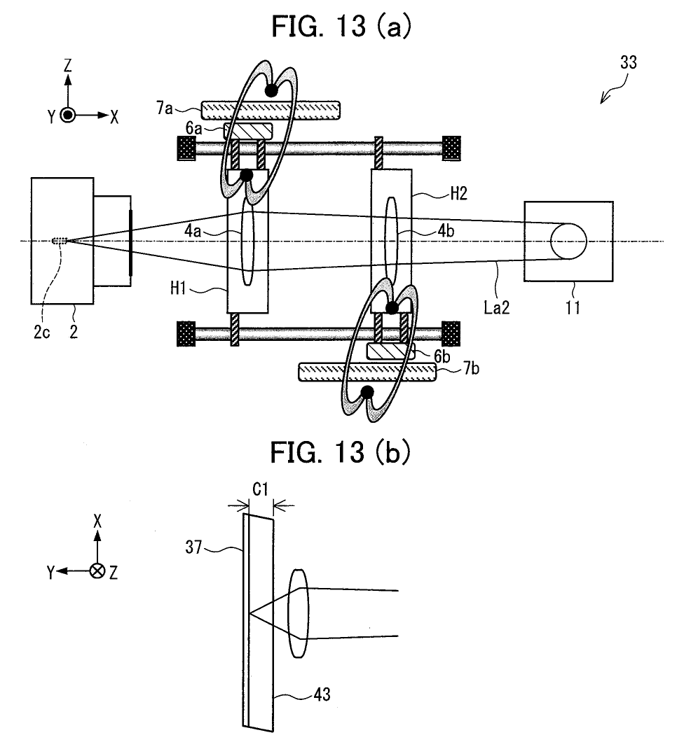

FIGS. 10 through 13 illustrate an optical pickup apparatus 33 of the present embodiment. FIG. 10(a) is an elevation view illustrating the optical pickup apparatus 33. FIG. 10(b), FIG. 11(a), FIG. 12(a), and FIG. 13(a) are plan views illustrating the optical pickup apparatus 33. FIG. 10(c), FIG. 11(b), FIG. 12(b), and FIG. 13(b) are views illustrating recording media 34, 35, 36, and 37 each being irradiated with an optical beam. Details of the recording media 34, 35, 36, and 37 are described later.

In addition to the arrangement of the optical pickup apparatus 1 of the first embodiment, the optical pickup apparatus 33 of the present embodiment includes a second collimating lens 4b, a second collimating lens holder H2, a second coil 6b, a second magnet 7b, a supporting point 8c, a supporting point 8d, a second neutral positioning rubber member 9b, and sliding bearings 10. The optical pickup apparatus 33 also includes an objective lens 39 instead of the objective lens 12. In FIG. 10(b), a part enclosed by a dashed line is a beam expander optical system 38.

The second collimating lens holder H2 includes the sliding bearings 10 with a hole so as to slide smoothly. Two shafts 5 fixed to supports 48 of a housing 47 are provided so as to be fitted into the holes of the sliding bearings 10. This causes the second collimating lens holder H2 to be supported by the shafts 5 so that the second collimating lens holder H2 is slidable in the X-axis direction. This makes it possible to realize a stable highly reliable optical pickup apparatus.

Alternatively, the second collimating lens holder H2 may be provided so as to slide along a convex guiding rail or along a concave guiding rail, which is formed, instead of the shafts 5, in the housing 47. This makes it possible to realize, without an expensive polished shaft, an inexpensive optical pickup apparatus.

The second coil 6b is attached to the sliding bearings 10. Furthermore, the second magnet 7b is provided to the housing 47. Although details are omitted here, under Fleming's left hand rule which is a universal rule of electromagnetic actuation, the amplitude and the polarity of an electric current flowing through the second coil 6b are controlled by control means, which is not illustrated, in accordance with a signal supplied by the collimating lens driving circuit controlling section 26, which is illustrated in FIG. 9. This causes the second collimating lens holder H2 to slide on an optical axis 19 in the X-axis direction so that the second collimating lens holder H2 is adjusted to be in a desired position. Laser light emitted from a light-emitting element 2a, 2b, or 2c passes through the first collimating lens 4a and the second collimating lens 4b, and comes out as a collimated beam. A fine adjustment of positions of the first collimating lens 4a and the second collimating lens 4b on the optical axis 19 can bring the collimated beam into any one state of the collimated state La1, the convergent state La2, and the divergent state La3.

As to the relative position of the second coil 6b and the second magnet 7b, they may be interchanged. Specifically, the second coil 6b may be fixed to the housing 47 and the second magnet 7a may be attached to the second collimating lens holder H2. This eliminates the need for current supply to the second collimating lens holder H2, which is a moving section. Accordingly, the second collimating lens holder H2 can be driven with current supply to the second coil 6b, which is fixed to the housing 47. This eliminates the need for an FPC and an extra-fine twisted wire that are used for current supply to the moving section. As a result, it possible to provide a low-cost highly reliable driving apparatus.

The second neutral positioning rubber member 9b is a member for keeping the second collimating lens holder H2 in a neutral position, namely, in a position for causing an incident optical beam onto the objective lens 39 to become collimated. One end of the second neutral positioning rubber member 9b is fixed to the supporting point 8c provided on the second collimating lens holder H2 and the other end of the second neutral positioning rubber member 9b is fixed to the supporting point 8d provided to the housing 47. As illustrated in FIG. 10(b), FIG. 11(a), FIG. 12(a), and FIG. 13(a), two rubber members each having a shape of an incomplete ring, which shape is the same as that of the first neutral positioning rubber member 9a, are used as the second neutral positioning rubber member 9b. The second neutral positioning member 9b has the same property of resilience with respect to a moving distance of the collimating lens as that of the first neutral positioning rubber member 9a. Accordingly, the second neutral positioning rubber member 9b produces resilience, for neutral positioning, that is almost linearly proportional in a moving range of the second collimating lens holder H2. This allows a stable correction of a spherical aberration.

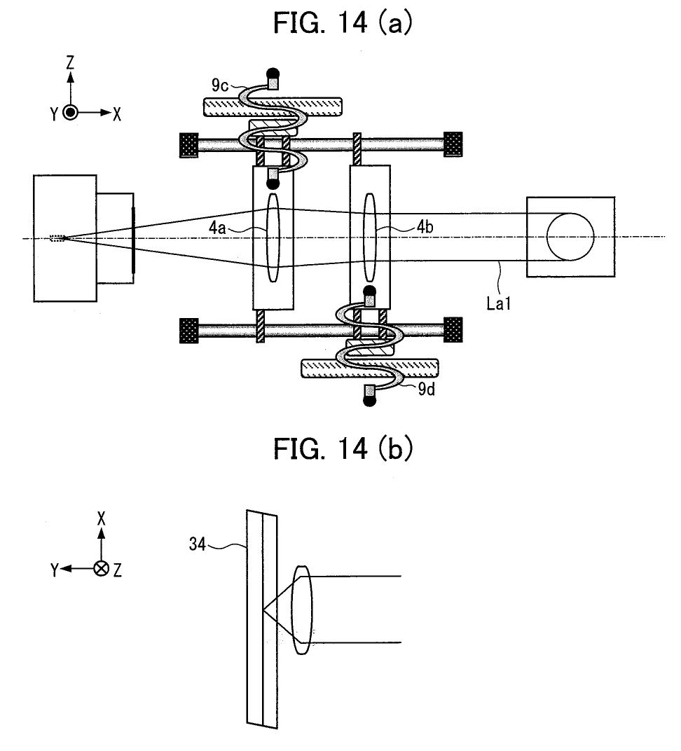

As illustrated in FIG. 14(a), a first neutral positioning rubber member 9c may be used instead of the first neutral positioning rubber member 9a ; a second neutral positioning rubber member 9d may be used instead of the second neutral positioning rubber member 9b. The second neutral positioning rubber member 9d has a zigzag shape that is formed by folding a strip rubber member several times, which zigzag shape is the same as the first neutral positioning rubber member 9c. The second neutral positioning rubber member 9d has the same property of resilience with respect to a moving range of the collimating lens as that of the first neutral positioning rubber member 9c. FIG. 14(b) is a view illustrating a recording medium being irradiated with an optical beam when using the optical pickup apparatus illustrated in FIG. 14(a).

In this case, each of the first collimating lens 4a and the second collimating lens 4b is moved within a range in which resilience that is linearly proportional in a moving distance of corresponding one of the first collimating lens 4a and the second collimating lens 4b can be obtained by use of corresponding one of the first neutral positioning rubber member 9c and the second neutral positioning rubber member 9d. This makes it possible to realize an aberration correcting mechanism that allows an easier correction of a spherical aberration when compared with a case where a conventional stepper motor is used. When compared with a case where a conventional stepper motor is used, in addition, the use of the first neutral positioning rubber member 9c and the second neutral positioning rubber member 9d makes it possible to realize a simpler lower-cost aberration correcting mechanism that allows an easier correction of a spherical aberration. Furthermore, it is possible to obtain a strength for keeping a neutral position, which strength is almost linearly proportional in a moving distance of the collimating lens within a movable range of the collimating lens, namely, within a range in which the collimating lens holder can slide. This makes it possible to realize an optical pickup apparatus that saves more space and has a property of strength for keeping a neutral position, which strength shows a higher linearity in the proportionality as compared with a case where a conventional stepper motor is provided.

As in the case of the first embodiment, the first neutral positioning rubber members 9b and 9d are not limited to the rubber member, provided that a linear resilience for neutral positioning is realized. For example, a leaf spring may be used instead of the first neutral positioning rubber members 9b and 9d.

The objective lens 39 is designed so that a spherical aberration of a spot on a recording surface of the recording medium 34, which is a DVD with a protective substrate 40 having a thickness of D1, can be minimized by bringing a collimated beam into the collimated state La1 when the recording medium 34 is irradiated with an optical beam by use of the optical pickup apparatus 33.

In addition to the light-emitting element 2a and a light-receiving element 2d, the semiconductor laser package 2 of the present embodiment includes the light-emitting elements 2b and 2c. The light-emitting element 2a emits blue-violet laser light that is used for reading data from a BD. The light-emitting element 2b emits infrared laser light that is used for reading data from a DVD. The light-emitting element 2c emits infrared laser light that is used for reading data from a CD.

The following first through fourth examples describe examples as to how spherical aberrations are corrected for different recording media, respectively.

### FIRST EXAMPLE

The recording medium 34 illustrated in FIG. 10(c) is a DVD with the protective substrate 40 having a thickness of D1. In order for an optical beam to be converged onto the recording surface of the recording medium 34, as illustrated in FIG. 10(b), (i) the first collimating lens holder H1 is kept in its neutral position by the operation of the first neutral positioning rubber member 9a and (ii) the second collimating lens holder H2 is kept in its neutral position by the operation of the second neutral positioning rubber member 9b.

This brings the collimated beam, which has passed through the second collimating lens 4b, into the collimated state La1. Then, the direction of the collimated beam is changed toward the recording medium by the reflecting mirror 11 so that the collimated beam enters the objective lens 39. A spherical aberration is thus corrected.

### SECOND EXAMPLE

The recording medium 35 illustrated in FIG. 11(b) is a BD with a protective substrate 41 having a thickness of B4. In order for an optical beam to be converged onto the recording surface of the recording medium 35, as illustrated in FIG. 11(a), (i) the first collimating lens holder H1 is slid toward the reflecting mirror 11 and (ii) the second collimating lens holder H2 is slid toward the semiconductor laser package 2.

The first collimating lens holder H1 is slid by an electromagnetic force caused by an electric current flowing through the first coil 6a and a magnetic field generated by the first magnet 7a. The second collimating lens holder H2 is slid by an electromagnetic force caused by an electric current flowing through the second coil 6b and a magnetic field generated by the second magnet 7b.

This brings the collimated beam, which has passed through the second collimating lens 4b, into the divergent state La3. Then, the direction of the collimated beam is changed toward the recording medium by the reflecting mirror 11 so that the collimated beam enters the objective lens 39. A spherical aberration is thus corrected.

### THIRD EXAMPLE

The recording medium 36 illustrated in FIG. 12(b) is a BD with a protective substrate 42 having a thickness of B5, which is thicker than the thickness B4 of the protective substrate 41. In order for an optical beam to be converged onto a recording surface of the recording medium 36, as illustrated in FIG. 12(a), (i) the first collimating lens holder H1 is slid toward the reflecting mirror 11 and (ii) the second collimating lens holder H2 is slid toward the semiconductor laser package 2. The distance between the first collimating lens holder H1 and the second collimating lens holder H2 is taken wider than that of the second example. In order for the distance to be taken wider, an electric current to be passed through each of the first coil 6a and the second coil 6b is set smaller than that of the second example.

This brings the collimated beam, which has passed through the second collimating lens 4b, into the divergent state La3. Then, the direction of the collimated beam is changed toward the recording medium by the reflecting mirror 11 so that the collimated beam enters the objective lens 39. A spherical aberration is thus corrected.

### FOURTH EXAMPLE

The recording medium 37 illustrated in FIG. 13(b) is a CD with a protective substrate 43 having a thickness of C1. In order for an optical beam to be converged onto a recording surface of the recording medium 37, as illustrated in FIG. 13(a), (i) the first collimating lens holder HI is slid toward the semiconductor laser package 2 and (ii) the second collimating lens holder H2 is slid toward the reflecting mirror 11.

The first collimating lens holder H1 is slid by an electromagnetic force caused by an electric current flowing through the first coil 6a and a magnetic field generated by the first magnet 7a. The second collimating lens holder H2 is slid by an electromagnetic force caused by an electric current flowing through the second coil 6b and a magnetic field generated by the second magnet 7b. The polarity of an electric current to be passed through each of the first coil 6a and the second coil 6b is reversed with respect to that of the second and third examples.

This brings the collimated beam, which has passed through the second collimating lens 4b, into the convergent state La2. Then, the direction of the collimated beam is changed toward the recording medium by the reflecting mirror 11 so that the collimated beam enters the objective lens 39. A spherical aberration is thus corrected.

As described in the first through fourth examples, in order for a spherical aberration, caused by an error in thickness of a protective substrate of a recording medium, to be corrected in a case where recording media are mutually different in type and in thickness of a protective substrate, the first collimating lens holder H1 is slid by an electromagnetic force caused by the first coil 6a and the first magnet 7a and the second collimating lens holder H2 is slid by an electromagnetic force caused by the second coil 6b and the second magnet 7b so that the degree of convergence/divergence of the collimated beam is changed. The collimated beam then enters the objective lens 39. The first collimating lens holder H1 and the second collimating lens holder H2 are thus slid so that a spherical aberration caused by an error in thickness of a substrate is cancelled.

In addition to the arrangement of the first embodiment, as described above, the optical pickup apparatus 33 of the present embodiment includes the second coil 6b, the second magnet 7b, and the second neutral positioning rubber member 9b, and further includes the objective lens 39 instead of the objective lens 12. As such, the optical pickup apparatus 33 is less expensive than an optical pickup apparatus including a conventional stepper motor. In addition, the optical pickup apparatus 33 can correct a spherical aberration with respect to each of a plurality of recording media typified by BD/HD-DVD/DVD/CD, to and from each of which the recording and reproduction of information are carried out by irradiating each of the recording media with respective one of optical beams that have different wavelengths and numerical apertures. Furthermore, in a case where a product including the optical pickup apparatus 33 is turned off and therefore no electric current flows through the first coil 6a, the first collimating lens holder H1 is kept in the neutral position by the operation of the first neutral positioning rubber member 9a. Similarly, since no electric current flows through the second coil 6b, the second collimating lens holder H2 is kept in the neutral position by the operation of the second neutral positioning rubber member 9b.

As such, the first collimating lens 4a and the second collimating lens 4b can move to the most appropriate respective positions in a short period of time when the product is turned on again.

### Summary of Embodiments

As described in the first and second embodiments, the optical pickup apparatus (1, 33) includes: a light source (the light-emitting element (2a)) for emitting laser light; the collimating lens (4a, 4b) for causing the incident laser light to be converted into an optical beam that is in the collimated state, the divergent state, or the convergent state, and for emitting the optical beam thus converted; the objective lens (12, 39) for converging onto a recording surface of a recording medium the optical beam from the collimating lens (4a, 4b); the light-receiving element (2d) for receiving reflected light from the recording medium; the collimating lens holder (H1, H2) for holding the collimating lens (4a, 4b); supporting means for supporting the collimating lens holder (H1, H2) so that the collimating lens holder (H1, H2) can freely move in the optical axis direction of the collimating lens (4a, 4b); driving means for driving the collimating lens holder (H1, H2) by electromagnetic force; and the neutral position recovery member that is provided between the housing (47) and the collimating lens holder (H1, H2) and that pulls back the collimating lens holder (H1, H2) to its neutral position in the optical axis direction of the collimating lens (4a, 4b), while no electromagnetic force is exerted on the collimating lens holder (H1, H2).

According to the arrangement, sliding the collimating lens to a desired position by use of an electromagnetic force produced by the driving means causes the optical beam to become collimated or non-collimated. The optical pickup apparatus thus generates an optical beam with an opposite spherical aberration for canceling a spherical aberration caused by one protective layer. As a result, the optical pickup apparatus can correct a spherical aberration of a spot on a multilayered recording surface of each of a plurality of recording media having respective protective layers that are mutually different in thickness.

In addition, the provision of the driving means and the neutral position recovery member allows the collimating lens to freely move in the optical axis direction. This makes it possible to always obtain fine recording/reproducing characteristics. Furthermore, the collimating lens is always kept in the constant position by the operation of the neutral position recovery member even while an apparatus including the optical pickup apparatus is turned OFF. As a result, this allows the provision of an inexpensive highly reliable optical pickup apparatus that reduces the next startup time of reproduction and thereby maintains amenity in use.

Moreover, in a case where the neutral position recovery member is an elastic member, the optical pickup apparatus saves more space when compared with a case where a conventional stepper motor is provided. None the less, the neutral position recovery member produces resilience for pulling back the collimating lens holder to the neutral position (resilience for neutral positioning) that resilience is almost linearly proportional in a moving range of the collimating lens holder. This allows a stable correction of a spherical aberration.

The optical pickup apparatus may include: the light source made up of a plurality of light sources; and the collimating lens, the collimating lens holder, the supporting means, the driving means, and the neutral position recovery member each including first and second one.

This allows the provision of an inexpensive optical pickup apparatus that can correct a spherical aberration with respect to each of a plurality of recording media typified by BD/HD-DVD/DVD/CD, to and from each of which the recording and reproduction of information are carried out by irradiating each of the recording media with respective one of optical beams that have different wavelengths and numerical apertures.

In the optical pickup apparatus, the supporting means may include: the shafts 5 fixed to the housing 47 along the optical axis of the collimating lenses 4a and 4b; and the sliding bearings 10 for causing the shafts 5 to support the collimating lens holders H1 and H2 so that the collimating lens holders H1 and H2 can freely slide. The driving means may include: the coils 6a and 6b through each of which an electric current flows, the coils 6a and 6b being attached to the sliding bearings 10, control means for controlling amplitude and polarity of the electric current flowing through each of the coils 6a and 6b, and the magnets 7a and 7b for generating a magnetic field, the magnets 7a and 7b being attached to the housing 47 so as to face the coils 6a and 6b, respectively. The neutral position recovery member may be an elastic member (the first neutral positioning rubber member 9a, the first neutral positioning rubber member 9c, the second neutral positioning rubber members 9b, and the second neutral positioning rubber member 9d, each of which pulls back the collimating lens holder H1 or H2 to the neutral position).

This allows correction of a spherical aberration of a spot on a recording surface of each of a plurality of recording media having respective protective layers that are mutually different in thickness. In addition, this allows the provision of an inexpensive highly reliable optical pickup apparatus that reduces the next startup time of reproduction and thereby maintains amenity in use. Furthermore, this saves more space when compared with a case where a conventional stepper motor is provided. None the less, the neutral position recovery member produces resilience for neutral positioning that resilience is almost linearly proportional in a moving range of the collimating lens holder. As a result, this allows a stable correction of a spherical aberration.

In the optical pickup apparatus, the supporting means may include: the shafts 5 fixed to the housing 47 along the optical axis of the collimating lenses 4a and 4b; and the sliding bearings for causing the shafts 5 to support the collimating lens holders H1 and H2 so that the collimating lens holders H1 and H2 can freely slide. The driving means may include: the magnets 7a and 7b for generating a magnetic field, the magnets 7a and 7b being attached to the sliding bearings 10; the coils 6a and 6b through each of which an electric current flows, the coils 6a and 6b being attached to the housing 47 so as to face the magnets 7a and 7b, respectively; and control means for controlling amplitude and polarity of the electric current flowing through each of the coils 6a and 6b. The neutral position recovery member may be an elastic member (the first neutral positioning rubber member 9a, the first neutral positioning rubber member 9c, the second neutral positioning rubber members 9b, and the second neutral positioning rubber member 9d, each of which pulls back the collimating lens holder H1 or H2 to the neutral position).

This eliminates the need for power supply to the collimating lens holders H1 and H2, which serve as moving sections, via an FPC or a copper wire. This allows a further improvement in response of the collimating lens holders H1 and H2. Furthermore, the coils 6a and 6b are each fixed to the housing 47. This further simplifies the structure of the optical pickup apparatus, thereby realizing an aberration correcting mechanism that is small, inexpensive, and highly reliable.

In the optical pickup apparatus, the elastic member (the first neutral positioning rubber member 9a and the second neutral positioning rubber member 9b) may include two rubber members each having a shape of a ring which is partially cut out.

This saves more space when compared with a case where a conventional stepper motor is provided. None the less, the first neutral positioning rubber members 9a and 9c and the second neutral positioning rubber members 9b and 9d each produce resilience for neutral positioning that resilience is almost linearly proportional in a moving range of the collimating lens holder. This allows a stable correction of a spherical aberration.

In the optical pickup apparatus, the elastic member (the first neutral positioning rubber member 9c and the second neutral positioning rubber member 9d) may have a zigzag shape that is formed by folding a strip rubber member several times.

This makes it possible to realize a simpler lower-cost aberration correcting mechanism that allows an easier correction of a spherical aberration, as compared with a case where a conventional stepper motor is used. In addition, this makes it possible to obtain a strength for keeping a neutral position that strength is almost linearly proportional in a moving distance of each of the collimating lenses 4a and 4b within respective movable ranges, namely, within ranges in which the collimating lens holders H1 and H2 can slide. As a result, as compared with a case where a conventional stepper motor is provided, this makes it possible to realize an optical pickup apparatus that saves more space and has a property of strength for keeping a neutral position, which strength shows a higher linearity in the proportionality.

In the optical pickup apparatus, the sliding bearing and the shaft of the supporting means may each include first and second one.

This makes it possible to control with stability and high precision the movement, in the optical axis direction, of the collimating lens 4a or 4b.

The optical pickup apparatus may further include: the guiding rail 50 having a convex or a concave part; and the guiding section 49 having a concave or a convex part, the guiding section 49 being provided on each of the collimating lens holders H1 and H2, wherein the convex part of the guiding rail 50 or the guiding section 49 is slidably fitted into the concave part of the guiding rail 50 or the guiding section 49, respectively.

This eliminates the need for an expensive polished shaft and makes it possible to inexpensively realize a mechanism for stably controlling the movement, in the optical axis direction, of the collimating lenses 4a and 4b.

The present invention is not limited to the description of the embodiments above, but may be altered by a skilled person within the scope of the claims. An embodiment based on a proper combination of technical means disclosed in different embodiments is encompassed in the technical scope of the present invention.

What is claimed is:

1. An optical pickup apparatus comprising:
a light source for emitting laser light;
a collimating lens for causing incident laser light to be converted into an optical beam that is in a collimated state, a divergent state, or a convergent state, and for emitting the optical beam thus converted;
an objective lens for converging onto a recording surface of a recording medium the optical beam from the collimating lens;
a light-receiving element for receiving reflected light from the recording medium;
a collimating lens holder for holding the collimating lens;
supporting means for supporting the collimating lens holder so that the collimating lens holder can freely move in an optical axis direction of the collimating lens;
driving means for driving the collimating lens holder by electromagnetic force; and
a neutral position recovery member, provided between a housing and the collimating lens holder, for pulling back the collimating lens holder to a neutral position in the optical axis direction of the collimating lens, while no electromagnetic force is exerted on the collimating lens holder.

2. The optical pickup apparatus as set forth in claim 1, comprising:
the light source made up of a plurality of light sources; and
the collimating lens, the collimating lens holder, the supporting means, the driving means, and the neutral position recovery member each including first and second one.

3. The optical pickup apparatus as set forth in claim 1, wherein
the supporting means includes:
a shaft fixed to the housing along the optical axis of the collimating lens; and
a sliding bearing for causing the shaft to support the collimating lens holder so that the collimating lens holder can freely slide, and the driving means includes:
a coil through which an electric current flows, the coil being attached to the sliding bearing,
control means for controlling amplitude and polarity of the electric current flowing through the coil, and
a magnet for generating a magnetic field, the magnet being attached to the housing so as to face the coil;
the neutral position recovery member is an elastic member for pulling back the collimating lens holder to the neutral position.

4. The optical pickup apparatus as set forth in claim 2, wherein
the supporting means includes:
a shaft fixed to the housing along the optical axis of the collimating lens; and
a sliding bearing for causing the shaft to support the collimating lens holder so that the collimating lens holder can freely slide, and
the driving means includes:
a coil through which an electric current flows, the coil being attached to the sliding bearing;
control means for controlling amplitude and polarity of the electric current flowing through the coil; and
a magnet for generating a magnetic field, the magnet being attached to the housing so as to face the coil,
the neutral position recovery member is an elastic member for pulling back the collimating lens holder to the neutral position.

5. The optical pickup apparatus as set forth in claim 1, wherein
the supporting means includes:
a shaft fixed to the housing along the optical axis of the collimating lens; and
a sliding bearing for causing the shaft to support the collimating lens holder so that the collimating lens holder can freely slide, and
the driving means includes:
a magnet for generating a magnetic field, the magnet being attached to the sliding bearing;
a coil through which an electric current flows, the coil being attached to the housing so as to face the magnet; and
control means for controlling amplitude and polarity of the electric current flowing through the coil,
the neutral position recovery member is an elastic member for pulling back the collimating lens holder to the neutral position.

6. The optical pickup apparatus as set forth in claim 2, wherein
the supporting means includes:
a shaft fixed to the housing along the optical axis of the collimating lens; and
a sliding bearing for causing the shaft to support the collimating lens holder so that the collimating lens holder can freely slide, and
the driving means includes:
a magnet for generating a magnetic field, the magnet being attached to the sliding bearing;
a coil through which an electric current flows, the coil being attached to the housing so as to face the magnet; and
control means for controlling amplitude and polarity of the electric current flowing through the coil,
the neutral position recovery member is an elastic member for pulling back the collimating lens holder to the neutral position.

7. The optical pickup apparatus as set forth in claim 1, wherein the neutral position recovery member includes two rubber members each having a shape of a ring which is partially cut out.

8. The optical pickup apparatus as set forth in claim 1, wherein the neutral position recovery member, having a zigzag shape, that is formed by folding a strip rubber member several times.

9. The optical pickup apparatus as set forth in claim 3, wherein the sliding bearing and the shaft of the supporting means each include first and second one.

10. The optical pickup apparatus as set forth in claim 4, wherein the sliding bearing and the shaft of the supporting means each include first and second one.

11. The optical pickup apparatus as set forth in claim 1, further comprising:
a guiding rail having a convex or a concave part; and
a guiding section having a concave or a convex part, the guiding section being provided on the collimating lens holder, wherein
the convex part of the guiding rail or the guiding section is slidably fitted into the concave part of the guiding rail or the guiding section, respectively.
